(19) United States
(12) Patent Application Publication
(10) Pub. No.: US 2019/0317364 A1
(43) Pub. Date: Oct. 17, 2019

(54) THIN TWO-DIMENSIONAL LOCAL DIMMING BACKLIGHT

(71) Applicant: Sharp Kabushiki Kaisha, Osaka (JP)

(72) Inventors: David James Montgomery, Oxford (GB); Takeshi Ishida, Osaka (JP)

(21) Appl. No.: 15/953,686

(22) Filed: Apr. 16, 2018

(51) Int. Cl. G02F 1/1335; F21V 8/00; G02F 1/1343; H05B 33/08; G09G 3/32; G09G 3/36

(52) U.S. Cl. CPC G02F 1/133603; G02B 6/0031; G09G 3/36; H05B 33/0845; G09G 3/32; G02F 1/1343

(57) ABSTRACT

A backlight assembly includes a light source, a light guide optically coupled to the light source that receives light from the light source, a substrate including an electrode layer and a hydrophobic surface located on the electrode layer, wherein the hydrophobic surface of the substrate is spaced apart from a surface of the light guide to define a cell gap, and a plurality of conductive liquid beads located within the cell gap. Liquid beads that are subject to an actuation voltage applied to the electrode layer are in an actuated state, and liquid beads that are not subject to an actuation voltage applied to the electrode layer are in a non-actuated state. When the liquid beads are in the non-actuated state, the liquid beads are in contact with the surface of the light guide for extracting light from the light guide, and when the liquid beads are in the actuated state, the liquid beads deform such that contact of the liquid beads with the surface of the light guide is reduced relative to the non-actuated state to reduce extraction of light from the lightguide, thereby dimming the backlight assembly.

### TECHNICAL FIELD

The present invention relates to high dynamic range (HDR) displays, and mobile displays in particular, that use a liquid crystal display (LCD) and a lightguide based active dimming backlight.

### BACKGROUND ART

Methods of achieving two-dimensional (2D) active dimming for televisions and comparable large area displays made up of direct lit light-emitting diodes (LEDs) behind a liquid crystal display (LCD) are known. Miniaturization of active dimming technology to mobile size displays, such as for example smartphones and tablets, involves replacing a lightguide of low thickness with an LED array. In addition, less LEDs are needed than viewing zones required for high quality high dynamic range (HDR) displays. Effective active dimming for mobile displays enhances power management and in particular can extend battery life.

Various attempts have been made to minimize display size in a manner the can be optimized for mobile devices. JP 2012129105 (Murata et al., published Jul. 5, 2012) uses optical elements on each direct lit LED to reduce thickness. U.S. 8,199,280 (Kim et al., issued Nov. 26, 2009) attempts to create a thinner direct lit 2D backlight by using individual lightguide elements. U.S. Pat. No. 5,686,979 (Weber et al., issued Nov. 11, 1997) attempts to create a switchable aperture using a second LC panel over the standard backlight.

Effective active dimming generally is not addressed for such devices. Miniaturizing a direct lit, large-display backlight to a mobile size suffers from two principal problems. First, the thickness is substantially reduced which means uniformity is difficult to achieve with a large number of LEDs, and second, the number of LEDs that can be used is less than the number of zones needed. Using lightguides or other optical elements on the LEDs of a direct lit backlight does reduce thickness, but not generally to an extent that can make the backlight mobile. In addition, the use of light guides or other optical elements does not solve the zone number issue. Using a second LC aperture (usually a passive matrix LC panel) on a normal backlight produces good quality zones at a low thickness. However, the efficiency is low as the full backlight needs to be on even for a small zone. The same is true for liquid aperture elements. The use of liquids that can be switched in a capillary fashion in a groove in the lightguide is simple, but there would not be a true dark state because of the index match in the groove, lowering efficiency.

In a separate field of technology, the use of fluidics to control display elements also is known. For example, WO 2007141218 (Feenstra et al., published Dec. 13, 2007) describes fluid switchable apertures as a display device with a normal backlight. U.S. Pat. No. 9,311,865 (Chung et al., issued Apr. 12, 2016) shows capillary grooves cut in a lightguide with two liquids and the amount of one relative to the other in the lightguide is controlled electrically.

### SUMMARY OF INVENTION

The present disclosure describes a technology that allows high quality two-dimensional (2D) active dimming that is optimized for mobile size displays, such as may be used for example in smartphones, tablets, and like devices. The present invention solves the thickness and zone count issues described above, while maintaining high efficiency.

Configurations described in this disclosure employ a bead of liquid, such as for example water, located on an electrode substrate and positioned just beneath a lightguide. When the voltage applied to the electrode is in the off or non-actuated state, the liquid bead is in contact with the lightguide and light is extracted to render the display device in a state of high brightness. When the voltage applied to the electrode is switched to the on or actuated state, a voltage in turn is generated across the bead. With said voltage applied, the bead changes shape due to electrofluidic forces, removing the bead from the lightguide which prevents or minimizes extracting light from the lightguide. In this manner, the display device is actively dimmed as the extraction of light is minimized or prevented. This arrangement can perform active dimming at high speed, typically about 1 ms, and with normal voltages commonly employed in display devices, typically in a range of ±12V, even for a liquid bead in air.

An aspect of the invention, therefore, is a backlight assembly having enhanced active dimming control. In exemplary embodiments, the backlight assembly includes a light source, a light guide optically coupled to the light source that receives light from the light source, a substrate including an electrode layer and a hydrophobic surface located on the electrode layer, wherein the hydrophobic surface of the substrate is spaced apart from a surface of the light guide to define a cell gap, and a plurality of conductive liquid beads located within the cell gap. Liquid beads that are subject to an actuation voltage applied to the electrode layer are in an actuated state, and liquid beads that are not subject to an actuation voltage applied to the electrode layer are in a non-actuated state. When the liquid beads are in the non-actuated state, the liquid beads are in contact with the surface of the light guide for extracting light from the light guide, and when the liquid beads are in the actuated state, the liquid beads deform such that contact of the liquid beads with the surface of the light guide is reduced relative to the non-actuated state to reduce extraction of light from the lightguide, thereby dimming the backlight assembly.

The surface of the lightguide that defines the cell gap may include a lenticular prism surface. In such configuration, a peak of each prism of the lenticular prism surface is aligned with a respective liquid bead such that each liquid bead is in contact with a respective prism with the peak of the respective prism being immersed within the liquid bead. When a liquid bead is actuated, the actuated liquid bead moves down the respective prism to reduce the light extraction by reduced contact of the actuated liquid bead with the respective prism. The plurality of liquid beads may be grouped in zones, and liquid beads within a given zone are commonly controlled to be in the actuated state or non-actuated state.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

FIG. 1 is a drawing depicting an overview of active dimming as is performed in embodiments of the present invention.

FIG. 2 is a drawing depicting experimental measurements of a wetting angle of a liquid bead relative to a hydrophobic substrate with applied voltage.

FIG. 3 is a drawing depicting an exemplary backlight assembly in accordance with embodiments of the present invention.

FIG. 4 is a drawing depicting the exemplary backlight assembly of FIG. 3, and showing additional details of the substrate upon which the liquid beads are located.

FIG. 5 is a drawing illustrating alternative electrode shapes or patterns for electrode configurations used in embodiments of the present invention.

FIG. 6 is a drawing depicting an exemplary configuration of a lightguide having a lenticular prism surface to demonstrate light extraction relative to liquid beads, in accordance with embodiments of the present invention.

FIG. 7 is a drawing depicting an exemplary light extraction relative to liquid beads using the lightguide having lenticular prisms of FIG. 6.

FIGS. 8A, 8B, and 8C are drawings showing exemplary alternative bead geometries in accordance with embodiments of the present invention.

FIG. 9 is a drawing depicting simulation results that demonstrate a change in height of a liquid bead as a function of the actuation voltage for the geometry of FIG. 8A.

FIG. 10 is a drawing demonstrating active dimming for a backlight assembly for a display device, the backlight assembly including a lightguide having a lenticular prism surface as illustrated in FIG. 5, with the bead geometry of FIG. 8A.

FIG. 11 is a drawing depicting an exemplary fabrication method of a backlight assembly in accordance with embodiments of the present invention.

FIG. 12 is a drawing depicting an exemplary time-sequential operation of the backlight assembly for grayscale control.

### DESCRIPTION OF EMBODIMENTS

Embodiments of the present invention will now be described with reference to the drawings, wherein like reference numerals are used to refer to like elements throughout. It will be understood that the figures are not necessarily to scale.

Generally, an aspect of the invention is a backlight assembly having enhanced active dimming control. In exemplary embodiments, the backlight assembly includes a light source, a light guide optically coupled to the light source that receives light from the light source, a substrate including an electrode layer and a hydrophobic surface located on the electrode layer, wherein the hydrophobic surface of the substrate is spaced apart from a surface of the light guide to define a cell gap, and a plurality of conductive liquid beads located within the cell gap. Liquid beads that are subject to an actuation voltage applied to the electrode layer are in an actuated state, and liquid beads that are not subject to an actuation voltage applied to the electrode layer are in a non-actuated state. When the liquid beads are in the non-actuated state, the liquid beads are in contact with the surface of the light guide for extracting light from the light guide, and when the liquid beads are in the actuated state, the liquid beads deform such that contact of the liquid beads with the surface of the light guide is reduced relative to the non-actuated state to reduce extraction of light from the lightguide, thereby dimming the backlight assembly.

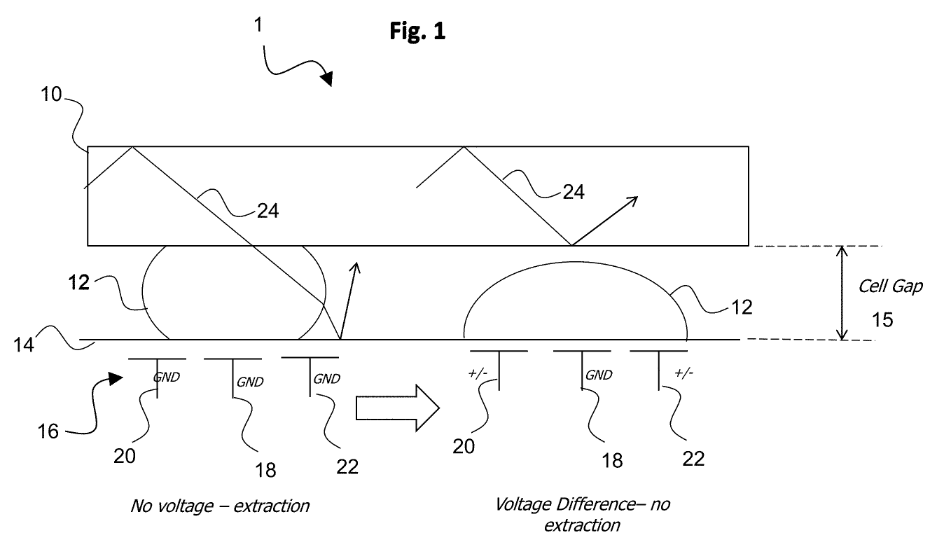

FIG. 1 is a drawing depicting an overview of active dimming as is performed in exemplary embodiments of the present invention. A backlight assembly 1 includes a lightguide 10 that is optically coupled to a light source, such as for example an array of light-emitting diodes (LEDs) (not shown) by total internal reflection from an edge of the lightguide in a known manner. The lightguide 10 is positioned above an array of conductive liquid beads 12 that are located on a hydrophobic substrate 14. In particular, a surface of the light guide 10 and the hydrophobic surface of the substrate 14 form a cell gap 15 in which a plurality of the conductive liquid beads 12 are located in an array. A single bead 12 in two alternative states is depicted for illustration, and in practice numerous liquid beads are arranged in a two-dimensional configuration or array that can have various arrangements as further detailed below. The liquid beads 12 are positioned relative to the lightguide 10 and patterned so that the light in the lightguide can be extracted by disruption of the total internal reflection. The pattern density changes with position along the lightguide so that the light extraction is even across the larger upper surface of the lightguide. Typically, more light extraction is needed farther away from the LEDs, and therefore the bead density would tend to increase with distance from the LEDs along the substrate.

The liquid beads 12 lie on an electrode arrangement centered on the respective beads. For example, an electrode arrangement 16 may include a center electrode 18 and peripheral electrodes 20 and 22. In operation, the center electrode 18 is held at ground and the peripheral electrodes 20 and 22 can be taken to an actuation voltage to apply a voltage difference across the liquid beads 12. The actuation voltage may be an alternating voltage.

In a first or non-actuated state of liquid beads within the backlight 1, as shown by the left portion of FIG. 1, all electrodes 18, 20, and 22 are held at ground such that there is no actuation voltage being applied, and thus no voltage difference across the liquid bead 12. In the non-actuated state, the liquid bead 12 is in contact with the lightguide 10, and light 24 is extracted evenly from the lightguide 10, and the backlight 1 is bright in such areas. In a second or actuated state of liquid beads within the backlight assembly 1, as shown by the right portion of FIG. 1, an actuation voltage is applied to the peripheral electrodes 20 and 22, which results in a voltage difference across the liquid bead 12. In response to said voltage difference, the liquid bead 12 deforms by an electrowetting effect of the applied voltage difference, by which the liquid bead 12 reduces or loses contact with the lightguide 10 by such deformation. In the second or actuated state, the light 24 is not extracted or light extraction is reduced, and the backlight assembly 1 is dim in such areas.

In exemplary embodiments, the conductive liquid beads 12 are water or a similar conducting liquid, and the material surrounding the liquid beads 12 within the cell gap 15 can be air or a low index oil. The water can have additional ionic materials dissolved in it to improve conductivity. The refractive index of the low index oil would need to be significantly less than the lightguide 10 and be non-conducting in nature. Although the above configuration is described in connection with configuring a backlight, with proper addressing electronics, the electrodes can be controlled individually to make a display device even without employing an additional LCD. It can be preferable, however, to use the above configuration as a backlight as described, in which the liquid beads are controlled in zones, with each liquid bead 12 taking the same voltage in a given zone. Light that is not extracted due to actuation within a given zone may be extracted in a later non-actuated area along the lightguide. The backlight, therefore, adapts how the light is extracted. When no voltage is applied and the backlight assembly 1 is in a non-actuated state, the pattern of the liquid beads 12 provides for uniform light extraction along the lightguide by varying the bead density with distance from the LEDs as referenced above. Similarly, actuation of one or more zones provides for even dim sections at which the light is not being extracted for enhanced and efficient active dimming.

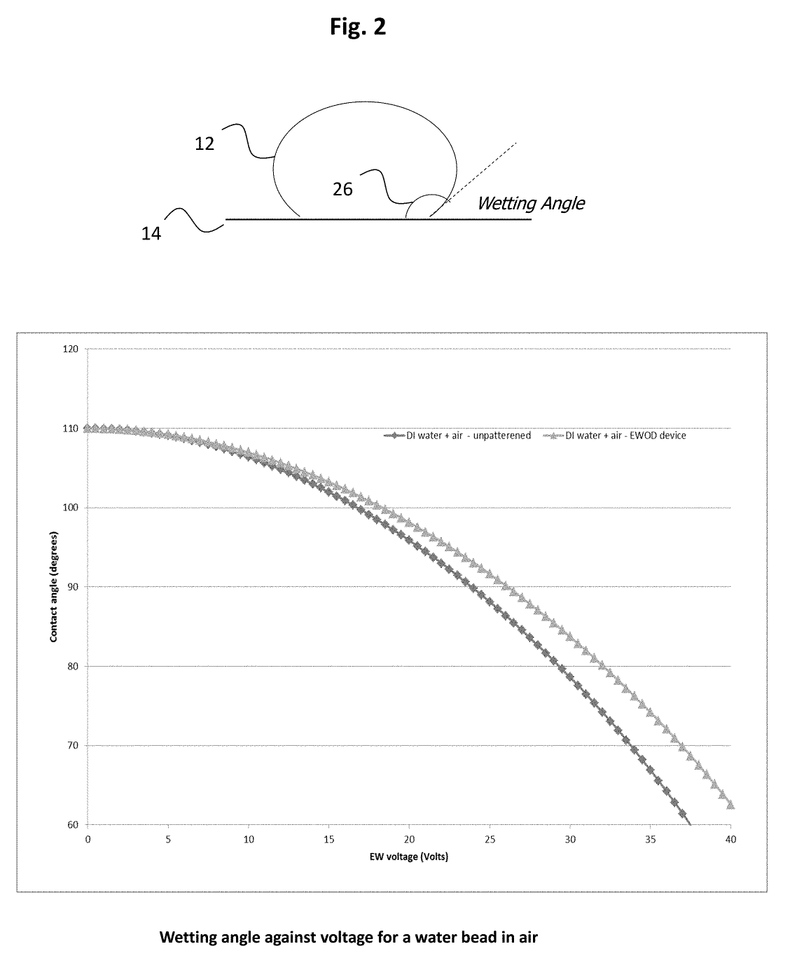

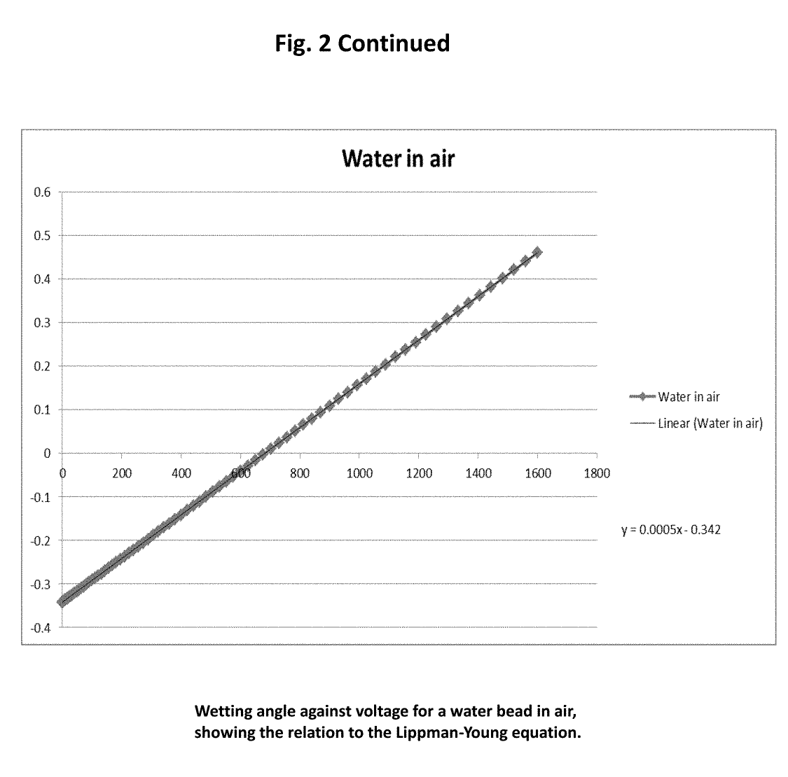

FIG. 2 is a drawing depicting experimental measurements of the wetting angle 26 of the liquid bead 12 relative to the substrate 14, with applied voltage. In this example, the liquid droplet is water located in air, and located using an amorphous fluoropolymer as a hydrophobic layer on the substrate 14. The theoretical underpinning of the electrowetting effect is governed by the Lippman-Young Equation, and water in air performs in high conformance with such principle. Using such principles, the system can be configured with an effective voltage relationship that can pull the liquid beads off of the lightguide when the actuation voltages are applied.

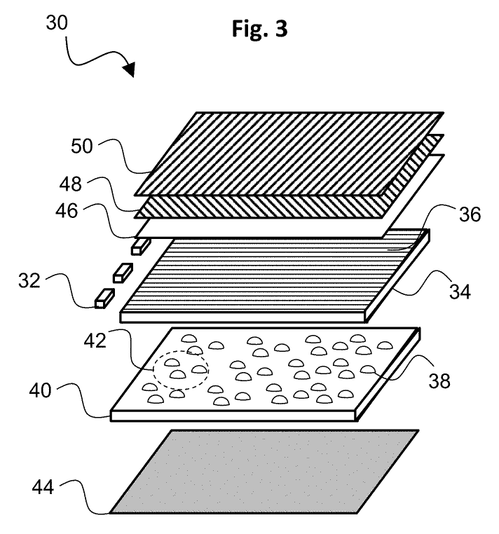

FIG. 3 is a drawing depicting an exemplary backlight assembly 30 in accordance with embodiments of the present invention. The backlight assembly 30 includes a light source configured as plurality of individual light sources 32 that are optically coupled to a lightguide 34. The individual light sources 32 may be light-emitting diodes (LEDs) or other suitable light sources as are known in the art that emit light to an edge of the lightguide 34. Light is extracted from the lightguide 34 for illumination of any suitable display device. The lightguide 34 may include surface features 36 as are known in the art, which provide enhanced extracting and directing of the light emitted from the lightguide.

The backlight assembly 30 further includes a plurality of liquid beads 38 located on a substrate 40. As referenced above, the liquid beads 38 may be water or another suitable conductive liquid, located in a surrounding material such as air or a low-index oil. A surface of the substrate 40 may include or be coated with a dielectric hydrophobic material. Suitable materials of the hydrophobic surface include materials of the amorphous fluoropolymer range, such as for example: poly(l,1,2,2-tetrafluoroethylene) (better known under its tradename Teflon®) and 1,1,1,2,2,3,3,4,4,5,5,6,6,-Tridecaflourooctane (better known under its tradename Cytop® or CT-SOLV100K). The liquid beads 38 may be configured in zones 42 of liquid beads that are controlled equally or together. In the example of FIG. 3, three liquid beads 38 are contained in each zone 42, although any suitable number of liquid beads may be included in any zone. In addition, different zones may have a same number or a different number of liquid beads within said respective zone.

The backlight assembly 30 may include one or more optical components for enhanced control of the light emission of light from the backlight assembly. The example configuration shown in FIG. 3 is particularly suitable for use in a mobile display device. For example, the backlight assembly 30 may include an enhanced specular reflector (ESR) 44 on a non-viewing side of the backlight assembly relative to the lightguide to redirect light toward the opposing viewing side of the backlight assembly. The backlight assembly 30 further may include one or more brightness enhancing films (BEFs) on a viewing side of the backlight assembly relative to the lightguide. Typical BEFs for a mobile device may include a diffuser 46 or crossed lenticular prism films 48 and 50. Light from the lightguide 34 tends to be extracted at an angle to normal, and the diffuser operates to provide a more uniform distribution of the angled light extracted from the lightguide. Two additional BEFs 48 and 50 are shown in the example of FIG. 3. Such BEFs may include an additional diffuser, crossed prism films and/or a diffusive reflective polarizer, which operate to improve brightness of the display device by collimating light emitted from the backlight assembly. It will be appreciated that the various optical components, including any reflectors, diffusers, polarizers, BEFs, and the like may be varied and arranged as is suitable for any particular display device application.

FIG. 4 is a drawing depicting the exemplary backlight assembly 30 of FIG. 3, and showing additional details of the substrate 40 upon which the liquid beads 38 are located. In the example of FIG. 4, from a viewing side the substrate 40 includes a hydrophobic layer 52, a dielectric layer 54, and a patterned electrode layer 56 including a plurality of electrode arrangements 58. As referenced above, the liquid beads 38 are positioned on the hydrophobic layer 52. Beneath the hydrophobic layer 52 is layered the dielectric layer 54, which acts as an ionic barrier to prevent shorting from the electrodes 58 through the liquid beads. The side of the lightguide 34 that is in contact with the liquid beads 38 also may be a hydrophobic surface or have a hydrophobic layer or coating to aid uniformity of contact of the liquid beads, but such an additional hydrophobic surface on the liquid bead side of the lightguide is optional. FIG. 4 further identifies a cell gap 35, which as referenced above essentially is a distance between the hydrophobic layer 52 on which the liquid beads 38 are located, and a lower surface of the lightguide 34. The cell gap 35, therefore, essentially defines the spacing that receives the liquid beads.

The electrode layer is patterned to include a plurality of electrode arrangements 58. FIG. 5 is a drawing illustrating alternative electrode shapes or patterns for electrode arrangements 58 used in embodiments of the present invention. Electrode line connections to each electrode arrangement are not shown in this diagram. Referring to FIG. 5 in combination with FIG. 4, the shape or patterns of the electrode arrangements 58 may take a variety of configurations. The electrode arrangement pattern can be square, rectangular or circular in structure, and electrodes structures may be connected to each other in each zone so that liquid beads within a common zone can be controlled together. In general, a double layer electrode structure may be employed to control separate zones of liquid beads. The electrode configurations further may be configured with different sizes and/or oriented in different directions as may be suitable. Each electrode arrangement includes a configuration comparably as described with respect to FIG. 1 above. The electrode arrangements 58, as to each liquid bead, may include a ground electrode and at least one additional electrode for receiving a voltage, and the actuation voltage comprises a voltage difference across the electrode arrangement. In this example, the electrode arrangement includes a center ground electrode 60 and peripheral electrodes 62 and 64. In operation, the center electrode 60 is held at ground and the peripheral electrodes 62 and 64 can be taken to an actuation voltage to apply a voltage difference across the liquid beads 38, and the actuating voltages may be alternating voltages. The electrodes may be metal or transparent, for example Indium Tin Oxide (ITO).

The actuated and non-actuated states may be employed as described above with respect to FIG. 1. Accordingly, in a first or non-actuated state of liquid beads 38, all electrodes 60, 62, and 64 are held at ground such that there is no voltage difference across liquid beads 38. In the non-actuated state, liquid beads are in contact with the lightguide 34 and light is extracted evenly from the lightguide, and the backlight assembly 30 is bright in such areas. In a second or actuated state of liquid beads, a voltage difference is applied to the peripheral electrodes 62 and 64, which results in a voltage across the liquid beads 38. In response to said voltage, the liquid beads deform by an electrowetting effect of the applied voltage difference by which actuated liquid beads lose contact or have reduced contact with the lightguide 34. In the second or actuated state, the light is not extracted or extraction is reduced, and the backlight assembly is dim in such areas.

Referring again to FIG. 3, the plurality liquid beads 38 may be arranged in the groups or zones 42 that can be controlled together, such that liquid beads within a given zone are commonly controlled to be in the actuated state or non-actuated state. In this manner, zones can be rendered bright or dim by controlling said different zones to be in non-actuated (bright) or actuated (dim) states. Accordingly, a display device is actively dimmed in whole or in part, as the extraction of light is minimized or prevented across one or more zones. The active dimming is performed at high speed, typically about 1 ms, and with normal voltages commonly employed in mobile display devices, typically in a range of approximately ±12V, and using a liquid bead in air. Effective active dimming is therefore achieved with minimal cost and complexity, in combination with optical components common in display devices, and mobile display devices in particular.

The surface of the lightguide that defines the cell gap may include a lenticular prism surface. In such configuration, a peak of each prism of the lenticular prism surface is aligned with a respective liquid bead such that each liquid bead is in contact with a respective prism with the peak of the respective prism being immersed within the liquid bead. When a liquid bead is actuated, the actuated liquid bead moves down the respective prism to reduce the light extraction by reduced contact of the actuated liquid bead with the respective prism. In this manner, precise greyscale controlling is achieved based on the relative amount of contact of the liquid beads with the prisms.

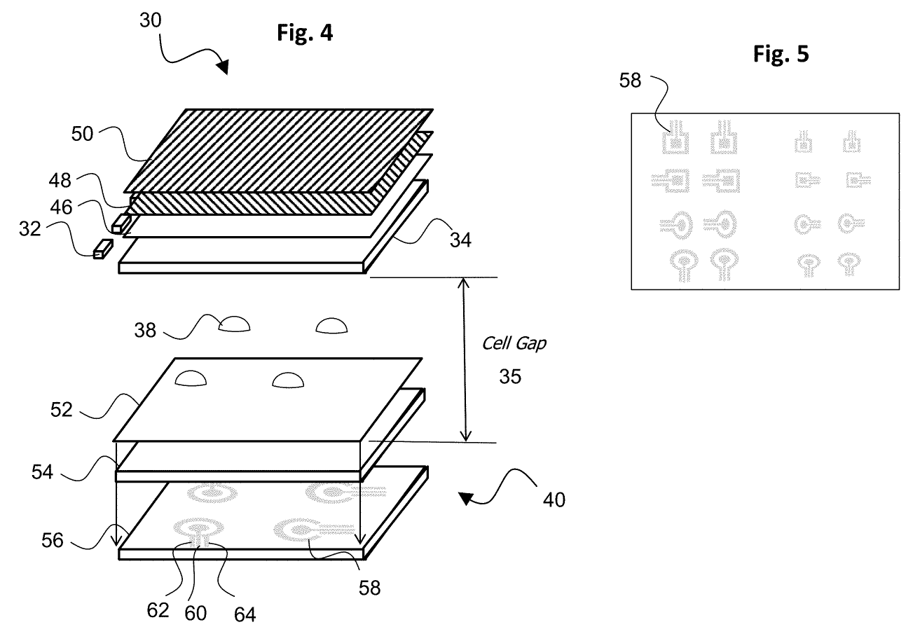

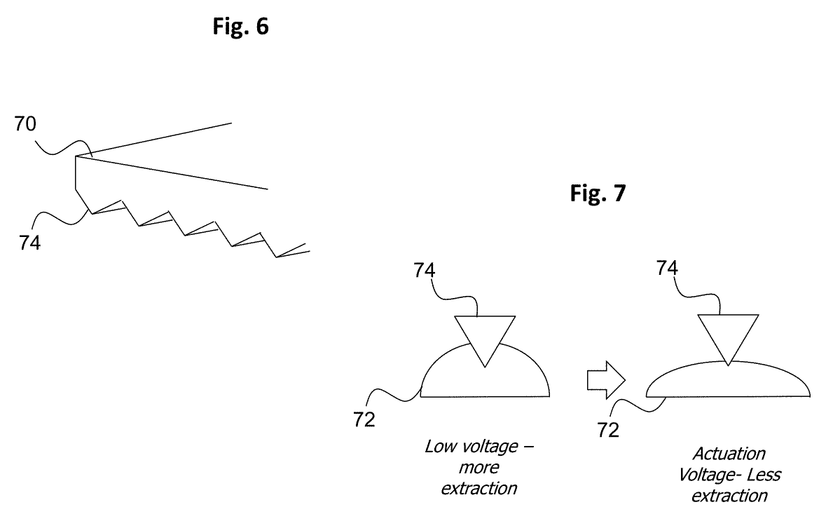

Referring to the figures, FIG. 6 is a drawing depicting an exemplary configuration of a lightguide 70 having a lenticular prism surface 74 to demonstrate light extraction relative to liquid beads 72, in accordance with embodiments of the present invention. FIG. 7 is a drawing depicting an exemplary light extraction relative to liquid beads using the lightguide having lenticular prisms of FIG. 6. These figures show a method of controlling grayscale values of the zone brightness. In the previous example embodiment, the lightguide surface is flat and the contact area between the spherical liquid beads and the lightguide surface can be difficult to control at intermediate voltages. This diagram shows a method to improve contact control by employing a lenticular configuration 74 on a surface of the lightguide 70 that contacts the liquid beads 72.

For example, the lightguide surface may be corrugated with lenticular prisms 74 on the lower surface of the lightguide 70. The lenticular prisms 74 may be continuous and of constant cross section, and the prisms 74 substantially are parallel with the general light direction from the light sources. Peaks of each prism 74 are aligned with a respective liquid bead 72 so that each liquid bead 72 is in contact with a prism 74 with a peak of the prism 74 being immersed within the respective liquid bead 72. The light is extracted as previously described when no voltage difference is applied to the liquid beads.

As shown in the progression illustrated in FIG. 7 from the non-actuated state (left portion of FIG. 7) to the actuated state (right portion of FIG. 7), when the voltage difference is applied across a liquid bead 72, the liquid bead moves down the prism 74 and reduces the amount of extraction via the reduced contact of the liquid bead 72 with the prism 74. When the liquid bead 72 leaves contact with the prism 74, the light propagates parallel to the prisms and so the light is not extracted, forming a dim zone. The use of the lenticular prism configuration improves the active dimming of the system by directing the light into a more collimated stripe of light within the lightguide, which enhances the active dimming control. In addition, bead interaction with the lenticular prism structure provides a more even grayscale of light being extracted.

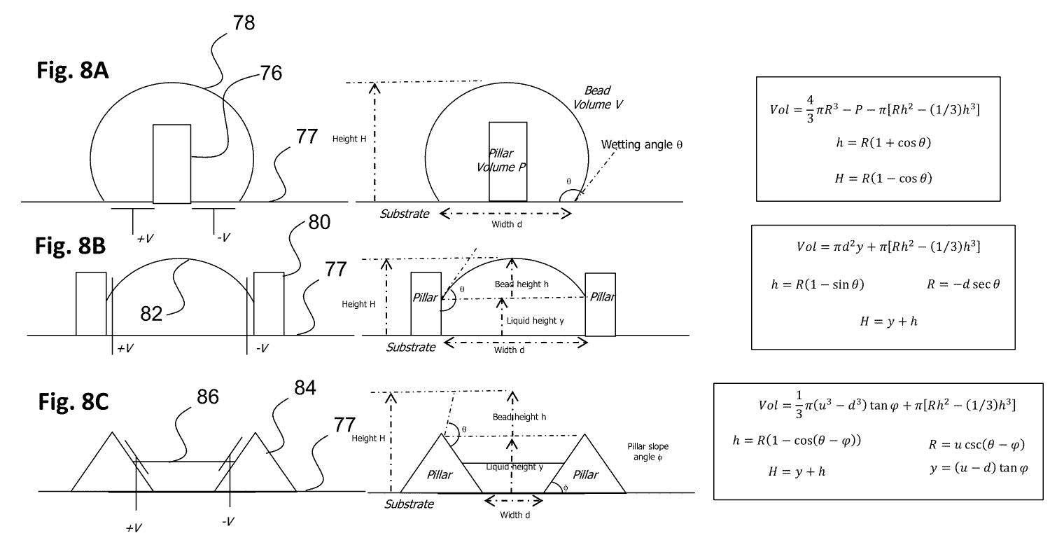

FIGS. 8A-8C are drawings showing exemplary alternative bead geometries in accordance with embodiments of the present invention. The device substrate on which the beads are located may be configured with surface support structures for supporting the liquid beads on the hydrophobic surface, which ensure that the liquid beads remain stationary or in the same place along the substrate. The figures depict three bead geometries and associated bead support structures that maintain the liquid beads in place.

FIG. 8A depicts a first configuration, referred to as Geometry (A), by which, for each liquid bead, a bead support structure is configured as a single pillar 76 on a substrate 77 that is placed centrally with respect to a liquid bead 78, i.e., with the liquid bead 78 positioned surrounding the central pillar 76. In the example in which the liquid bead is made of water, the central pillar should be hydrophilic such that the liquid bead interacts with the pillar to maintain the bead in place. With such configuration the liquid bead maintains a largely circular shape when in the non-actuated state. FIG. 8A further depicts the manner of application of the actuation voltages +V and −V to generate the voltage difference across the liquid bead, with the electrodes being located peripherally relative to central pillar 76. The pillar may be a rectangular, circular or other cylinder or pyramidal structure.

FIG. 8B depicts a second configuration, referred to as Geometry (B), by which a bead support structure, for each liquid bead, is configured as an edge pillar 80 on the substrate 77 that is placed along the edges of a liquid bead 82, i.e., in three dimensions an edge pillar would surround a bead with the bead positioned within the confines of the edge pillar. The edge pillar 80 may be configured in a square or circular arrangement about the liquid bead 82 so as to confine the liquid bead on all sides. In the example in which the liquid bead is made of water, the edge pillar should be hydrophobic to maintain the liquid bead in place. With such configuration, depending upon the geometry of the pillar the liquid bead can be configured to maintain a more ovular shape as compared to Geometry (A) when in the non-actuated state. FIG. 8B further depicts the manner of application of the actuation voltages +V and −V to generate the voltage difference across the liquid bead, with the electrodes being configured as edge electrodes located along an inner surface of the edge pillar.

FIG. 8C depicts a third configuration, referred to as Geometry (C), by which a bead support structure is configured as an edge triangular pillar 84 on the substrate 77 that is placed along the edges of a liquid bead 86, i.e., in three dimensions triangular pillar would surround a bead with the bead positioned within the confines of the triangular pillar. The triangular pillar 84 may be configured in a square or circular arrangement with triangular cross-section about the liquid bead 86 so as to confine the liquid bead on all sides. In the example in which the liquid bead is made of water, the triangular pillar should be hydrophobic to maintain the liquid bead in place. With such configuration, the liquid bead maintains a shape having a flattened surface as compared to the more rounded shapes of Geometries (A) and (B). FIG. 8C further depicts the manner of application of the actuation voltages +V and −V to generate the voltage across the liquid bead, with the electrodes being configured as edge electrodes located along the inner sloped surface of the triangular pillar.

FIGS. 8A-8C also include respective calculations of bead volume associated with each of the three geometries. The bead volumes generally are a function of the bead height and the wetting angle relative to the pillars in each geometry. The volume calculations are significant in setting the structural parameters of the device in relation to voltage parameters. In this manner, the bead geometries, including the related support structure configuration, can be selected and configured to correspond to appropriate actuation voltages to obtain the required bead separation from the lightguide for active dimming.

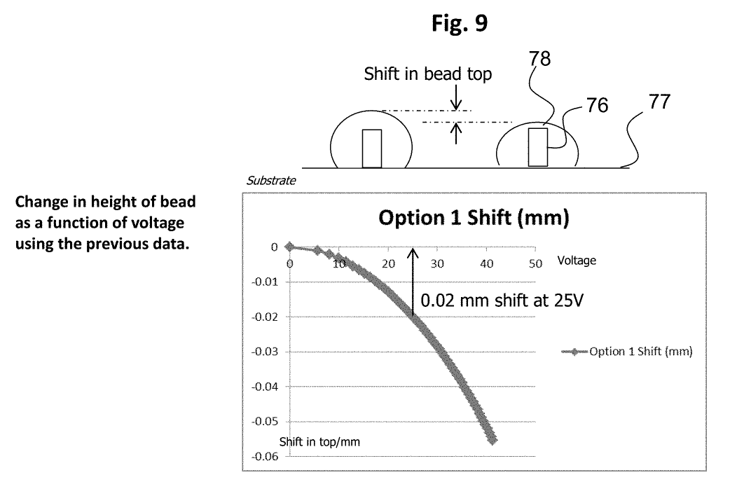

For example, FIG. 9 is a drawing depicting simulation results that demonstrate a change in height of a liquid bead as a function of the actuation voltage for the Geometry (A) of FIG. 8A. The example of FIG. 9 assumes a constant volume and calculating the change in height with change in wetting angle, with the wetting angle being calculated from the Lippman-Young Equation using the measured values. In this example, a bead volume of 4 nL is employed, with a bead radius of 108.6 μm and height of 146 μm. With such configuration, a change in height of 20 μm can be observed with a voltage difference of 25V across the liquid bead, which could be obtained using actuation voltages of ±12.5V applied to the peripheral electrode relative to ground. The 20 μm change upon actuation thus can be the basis for structurally configuring the backlight assembly, in that such calculation indicates the amount by which the liquid beads can pull away from the backlight for active dimming. Comparable calculations can be performed for any of the alternative geometries to set the structural parameters and configuration of the overall backlight assembly.

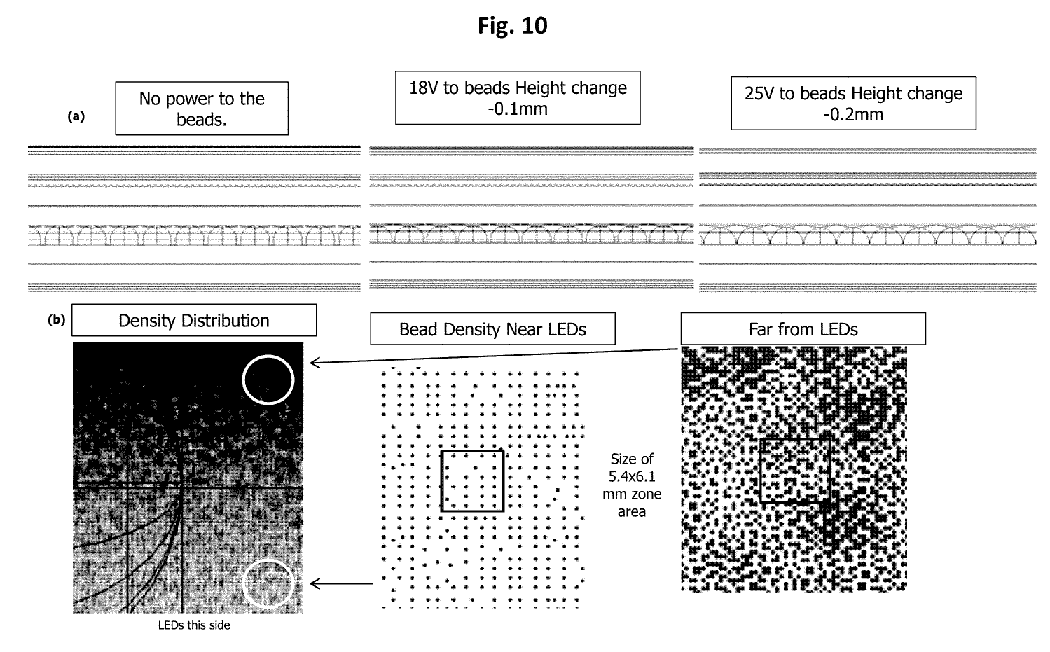

FIG. 10 is a drawing demonstrating active dimming for a backlight assembly for a display device, the backlight assembly including a lightguide having a lenticular prism surface as illustrated in FIG. 5, with the bead Geometry (A) of FIG. 8A. In this example, a backlight assembly is incorporated into a 15.6″ display device with 2000 zones of liquid bead groups, each having a zone size of 5.4×6.1 mm. With such configuration, a minimum of 20 beads would be present within each zone. The precise density (i.e., number of beads per zone) can be varied with distance from the LEDs to produce a more uniform light output in all states of operation. In exemplary embodiments, the density of the liquid beads increases with distance from the light source LEDs. The uniformity for a given thickness display is higher than for a direct view type backlight or other type with just one light source per zone, for example a micro-LED backlight. This arrangement could then have a lower thickness more similar to lightguide based backlights that do not have active dimming.

In particular, FIG. 10 illustrates the manner by which the liquid beads are arranged to provide an optimal uniform output from the backlight assembly. With an actuation voltage corresponding to a voltage difference of 18V across the beads, partial dimming is achieved in that bead height is reduced by about 0.1 mm, thereby partially removing the beads from the prism structures of the lightguide. The display device is therefore partially dimmed. With an actuation voltage corresponding to a voltage difference of 25V across the beads, full dimming is achieved in that bead height is reduced by 0.2 mm, thereby fully removing the beads from the prism structures of the lightguide to achieve a darker state. To achieve a highly uniform light output, a density of the liquid beads is smaller closer to the LEDs as compared to farther from the LEDs. The density of liquid beads are more dense farther from the LEDs because more extraction points are required for a more uniform output.

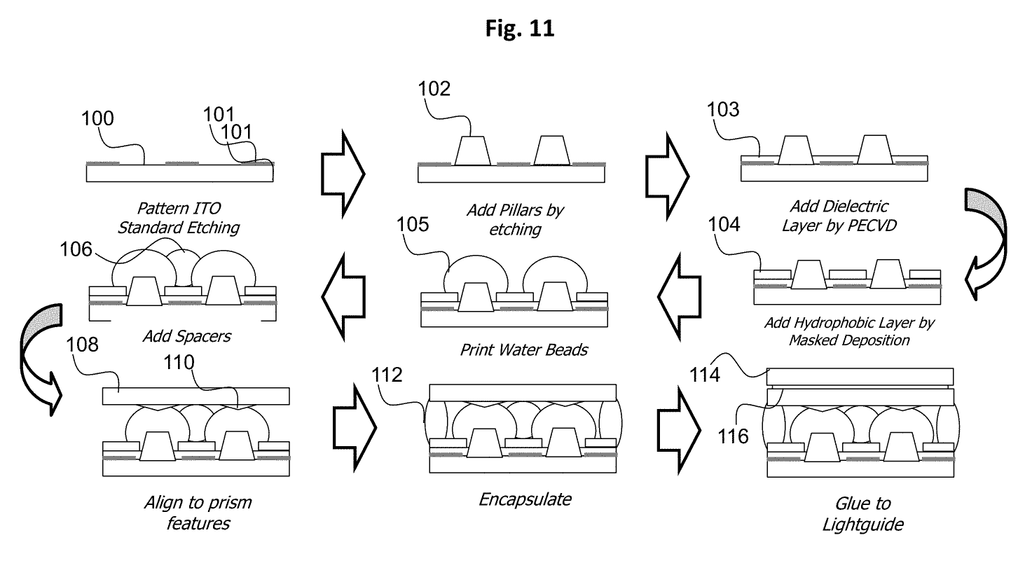

FIG. 11 is a drawing depicting an exemplary fabrication method of a backlight assembly in accordance with embodiments of the present invention. This example relates to fabrication of a backlight assembly including a lightguide having a lenticular prism surface as illustrated in FIG. 5, with the bead Geometry (A) of FIG. 8A. It will be appreciated, however, that comparable principles may be employed to fabricate a backlight assembly in accordance with any of the embodiments. Each portion of FIG. 11 illustrates a step in the fabrication method.

In a first step, an ITO etching process is performed on a transparent substrate 100 to form the desired electrode pattern 101. In a second step, the central pillars 102 are created using conventional photoresist processing using a suitable hydrophilic material. In a third step, the dielectric layer 103 is added using a mask step so that the pillars are not coated. In a fourth step, the hydrophobic coating or layer (e.g., the Cytop® layer) 104 is added, and by using the same masking of the pillars 102 so as not to coat the pillars. In a fifth step, the liquid beads 105 are then printed onto the pillars and hydrophobic layer using existing printing technology. In a sixth step, spacers 106 are employed to maintain the desired thickness of the bead area. In a seventh step, a top substrate 108 having the lenticular aligned prism features 110 is applied, such that one prism feature is aligned with a respective liquid bead. In an eighth step, the assembly then is encapsulated by the addition of side walls 112. In a ninth step, the top substrate is then fixed to the lightguide 114, for example by gluing using an index matched glue 116. This prevents extraction from the encapsulation glue at the side near the LEDs. The assembly is then properly positioned relative to the light sources to form a structure comparably as shown in FIGS. 3 and 4.

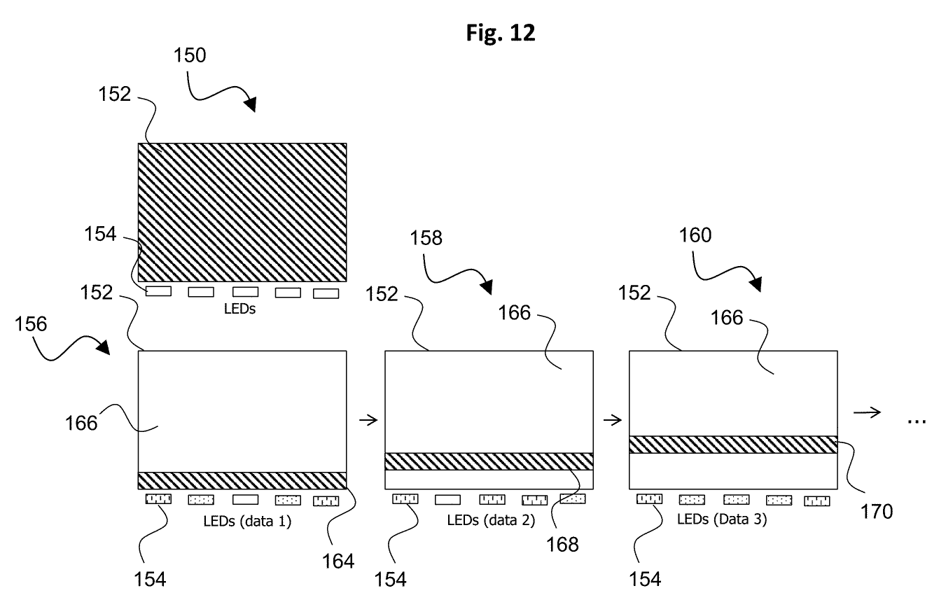

The backlight assembly accordingly to any of the embodiments may be employed for enhanced active dimming control, which is depicted in FIG. 12.

Generally, a method of operating a backlight assembly includes the steps of providing a backlight assembly according to any of the embodiments, and sequentially operating the backlight assembly to illuminate the array of liquid beads in sequence by: time-sequentially switching on the light source to apply respective data for each sequence; and time-sequentially retaining an extracting zone within the array of liquid beads by maintaining the extracting zone in a non-actuated state for light extraction corresponding to the data, while generating a non-extracting zone that does not extract light by actuating liquid beads in the non-extracting zone. The backlight assembly is sequentially operated in a time of one frame during which the array of liquid beads is illuminated.

FIG. 12 is a drawing depicting an exemplary time-sequential operation of the backlight assembly for active dimming control. In this example operation, the grayscale switching of the liquid beads is not necessary, and liquid beads therefore are “non-actuated” or “actuated”, i.e. extracting or non-extracting. With this approach electrical control is easier, and also uniformity in the “gray” state can be better controlled. The backlight assembly may be configured as described above, including the lightguide having lenticular prism features as shown in FIG. 5 and with any suitable bead geometry.

FIG. 12 depicts an initial state 150 in which the liquid beads of a backlight assembly 152 are in an extracting state, i.e., the entire array of liquid beads is non-actuated. The liquid beads may have a constant density distribution within respective rows, and also may be electrically connected in horizontal lines for rows for a row-based actuation. LEDs 154 also are in an initial state with no light emission data being applied. As illustrated in the progression through states 156, 158, and 160, data for each horizontal row of zones is switched on the LEDs one row at a time (data 1, then data 2, then data 3) and only one corresponding row is maintained as “extracting”. All other rows are then actuated to apply a voltage difference to the beads, thereby pulling the actuated beads from the lightguide to render such rows non-extracting. Note that although reference is made to rows, a like control can be performed on a column basis.

In exemplary embodiments, the extracting zone in each sequence is a different row or column within the array of liquid beads. For example, as illustrated in FIG. 12 in state 156 data 1 is applied to the LEDs, and a first row 164 is extracting while a zone 166 is actuated such that all other rows are non-extracting in the zone 166. For state 158, data 2 is applied to the LEDs for the next row zone data, and a next row 168 is extracting. The previous row is switched to non-extracting and thus is now part of the non-extracting zone 166. For state 160, data 3 is applied to the LEDs for the next row zone data, and a next row 170 is extracting. The previous row is switched to non-extracting and thus is now part of the non-extracting zone 166.

This process proceeds until all the rows are illuminated in the time of one frame. For example for 2000 zones such as in the configuration of FIG. 10, which can be achieved with an array of 32×64 zones, 32 separate rows can be illumined in one time frame. Depending on the image being displayed, it is not necessary to simply add data to one row only. Rather, the process can proceed by multiplexing, so that the light from the LEDs can illuminate more than one row to achieve the same image. This requires fewer separate steps than just illuminating each row in turn.

An aspect of the invention, therefore, is a backlight assembly having enhanced active dimming control. In exemplary embodiments, the backlight assembly includes a light source; a light guide optically coupled to the light source that receives light from the light source; a substrate including an electrode layer and a hydrophobic surface located on the electrode layer, wherein the hydrophobic surface of the substrate is spaced apart from a surface of the light guide to define a cell gap; and a plurality of conductive liquid beads located within the cell gap. Liquid beads that are subject to an actuation voltage applied to the electrode layer are in an actuated state, and liquid beads that are not subject to an actuation voltage applied to the electrode layer are in a non-actuated state. When the liquid beads are in the non-actuated state, the liquid beads are in contact with the surface of the light guide for extracting light from the light guide, and when the liquid beads are in the actuated state, the liquid beads deform such that contact of the liquid beads with the surface of the light guide is reduced relative to the non-actuated state to reduce extraction of light from the lightguide, thereby dimming the backlight assembly. The backlight assembly may include one or more of the following features, either individually or in combination.

In an exemplary embodiment of the backlight assembly, the substrate includes from a viewing side: the hydrophobic surface, a dielectric layer, and the electrode layer.

In an exemplary embodiment of the backlight assembly, the electrode layer is patterned to include a plurality of electrode arrangements.

In an exemplary embodiment of the backlight assembly, the plurality of electrode arrangements comprises, as to each liquid bead, a ground electrode and at least one additional electrode for receiving a voltage, and the actuation voltage comprises a voltage difference across the electrode arrangement.

In an exemplary embodiment of the backlight assembly, the plurality of electrode arrangements comprises, as to each liquid bead, a center ground electrode and two peripheral electrodes.

In an exemplary embodiment of the backlight assembly, the surface of the lightguide that defines the cell gap has a lenticular prism surface; a peak of each prism of the lenticular prism surface is aligned with a respective liquid bead such that each liquid bead is in contact with a respective prism with the peak of the respective prism being immersed within the liquid bead when the liquid bead is in a non-actuated state; and when a liquid bead is actuated the actuated liquid bead moves down the respective prism to reduce the light extraction by reduced contact of the actuated liquid bead with the respective prism.

In an exemplary embodiment of the backlight assembly, when the liquid beads are in the actuated state, the liquid beads are not in contact with the surface of the lightguide that defines the cell gap.

In an exemplary embodiment of the backlight assembly, the plurality of liquid beads is grouped in zones, and liquid beads within a given zone are commonly controlled to be in the actuated state or non-actuated state.

In an exemplary embodiment of the backlight assembly, the substrate further comprises support structures for supporting the liquid beads on the hydrophobic surface.

In an exemplary embodiment of the backlight assembly, the support structures comprise, for each liquid bead, a hydrophilic central pillar with the liquid bead surrounding the central pillar.

In an exemplary embodiment of the backlight assembly, the support structures comprise, for each liquid bead, a hydrophobic edge pillar that is placed along an edge of the liquid bead.

In an exemplary embodiment of the backlight assembly, the edge pillar is a triangular pillar.

In an exemplary embodiment of the backlight assembly, a density of the liquid beads increases with distance from the light source.

In an exemplary embodiment of the backlight assembly, the liquid beads are water located in air within the cell gap.

In an exemplary embodiment of the backlight assembly, the light source comprises a plurality of light emitting diodes that are positioned to emit light to an edge of the light guide.

In an exemplary embodiment of the backlight assembly, the backlight assembly further includes one or more optical components for the control of light emission from the backlight assembly.

In an exemplary embodiment of the backlight assembly, optical components include a specular reflector on a non-viewing side of the backlight assembly relative to the lightguide, and at least one brightness enhancing film on a viewing side of the backlight assembly relative to the lightguide.

Another aspect of the invention is a method of operating a backlight assembly for enhanced active dimming control. In exemplary embodiments, the method includes the steps of: providing a backlight assembly accordingly to any of the embodiments, and sequentially operating the backlight assembly to illuminate the array of liquid beads in sequence by: time-sequentially switching on the light source to apply respective data for each sequence; and time-sequentially retaining an extracting zone within the array of liquid beads by maintaining the extracting zone in a non-actuated state for light extraction corresponding to the data, while generating a non-extracting zone that does not extract light by actuating liquid beads in the non-extracting zone. The backlight assembly is sequentially operated in a time of one frame during which the array of liquid beads is illuminated. The method may include one or more of the following features, either individually or in combination.

In an exemplary embodiment of the method of operating a backlight assembly, the extracting zone corresponds in each sequence to a different row or column within the array of liquid beads.

In an exemplary embodiment of the method of operating a backlight assembly, sequentially operating the backlight assembly includes placing the backlight assembly in an initial state in which the entire array of liquid beads is non-actuated, and no light emission data is being applied to the light source.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

### INDUSTRIAL APPLICABILITY

The present invention relates to active dimming of backlight assemblies for display devices. Embodiments of the present invention are applicable to many display devices to permit display devices of high resolution and high image quality. Examples of such devices include televisions, mobile phones, personal digital assistants (PDAs), tablet and laptop computers, desktop monitors, digital cameras, and like devices. The present invention is particularly suitable for active dimming in mobile display devices.

REFERENCE SIGNS LIST
1—backlight assembly
10—lightguide
12—conductive liquid beads
14—hydrophobic substrate
15—cell gap
16—electrode arrangement
18—center electrode
20—peripheral electrode
22—peripheral electrode
24—light
26—electrowetting angle
30—backlight assembly
32—individual light sources
34—lightguide
35—cell gap
36—surface features
38—liquid beads
40—substrate
42—liquid bead zones
44—enhanced specular reflector (ESR)
46—diffuser
48—brightness enhancement film
50—brightness enhancement film
52—hydrophobic layer
54—dielectric layer
56—patterned electrode layer
58—electrode arrangements
60—center ground electrode
62—peripheral electrode
64—peripheral electrode
70—lightguide
72—liquid beads
74—lenticular prism surface
76—central pillar
77—substrate
78—liquid bead
80—edge pillar
82—liquid bead
84—triangular edge pillar
86—liquid bead
100—transparent substrate
101—electrode pattern
102—central pillars
103—dielectric layer
104—hydrophobic coating or layer
105—liquid beads
106—spacers
108—top substrate
110—lenticular prism features
112—side walls
114—lightguide
116—index matched glue
150—initial state
152—backlight assembly
154—LEDs
156—data 1 state
158—data 2 state
160—data 3 state
164—extracting zone row
166—non-extracting zone
168—next extracting zone row
170—next extracting zone row

1. A backlight assembly comprising:
a light source;
a light guide optically coupled to the light source that receives light from the light source;
a substrate including an electrode layer and a hydrophobic surface located on the electrode layer, wherein the hydrophobic surface of the substrate is spaced apart from a surface of the light guide to define a cell gap; and
a plurality of conductive liquid beads located within the cell gap;
wherein liquid beads that are subject to an actuation voltage applied to the electrode layer are in an actuated state, and liquid beads that are not subject to an actuation voltage applied to the electrode layer are in a non-actuated state; and
wherein when the liquid beads are in the non-actuated state, the liquid beads are in contact with the surface of the light guide for extracting light from the light guide, and when the liquid beads are in the actuated state, the liquid beads deform such that contact of the liquid beads with the surface of the light guide is reduced relative to the non-actuated state to reduce extraction of light from the lightguide, thereby dimming the backlight assembly.

2. The backlight assembly of claim 1, wherein the substrate includes from a viewing side: the hydrophobic surface, a dielectric layer, and the electrode layer.

3. The backlight assembly of claim 2, wherein the electrode layer is patterned to include a plurality of electrode arrangements.

4. The backlight assembly of claim 3, wherein the plurality of electrode arrangements comprises, as to each liquid bead, a ground electrode and at least one additional electrode for receiving a voltage, and the actuation voltage comprises a voltage difference across the electrode arrangement.

5. The backlight assembly of claim 4, wherein the plurality of electrode arrangements comprises, as to each liquid bead, a center ground electrode and two peripheral electrodes.

6. The backlight assembly of claim 1, wherein:
the surface of the lightguide that defines the cell gap has a lenticular prism surface;
a peak of each prism of the lenticular prism surface is aligned with a respective liquid bead such that each liquid bead is in contact with a respective prism with the peak of the respective prism being immersed within the liquid bead when the liquid bead is in a non-actuated state; and
when a liquid bead is actuated the actuated liquid bead moves down the respective prism to reduce the light extraction by reduced contact of the actuated liquid bead with the respective prism.

7. The backlight assembly of claim 1, wherein when the liquid beads are in the actuated state, the liquid beads are not in contact with the surface of the lightguide that defines the cell gap.

8. The backlight assembly of claim 1 wherein the plurality of liquid beads is grouped in zones, and liquid beads within a given zone are commonly controlled to be in the actuated state or non-actuated state.

9. The backlight assembly of claim 1, wherein the substrate further comprises support structures for supporting the liquid beads on the hydrophobic surface.

10. The backlight assembly of claim 9, wherein the support structures comprise, for each liquid bead, a hydrophilic central pillar with the liquid bead surrounding the central pillar.

11. The backlight assembly of claim 9, wherein the support structures comprise, for each liquid bead, a hydrophobic edge pillar that is placed along an edge of the liquid bead.

12. The backlight assembly of claim 11, wherein the edge pillar is a triangular pillar.

13. The backlight assembly of claim 1, wherein a density of the liquid beads increases with distance from the light source.

14. The backlight assembly of claim 1, wherein the liquid beads are water located in air within the cell gap.

15. The backlight assembly of claim 1, wherein the light source comprises a plurality of light emitting diodes that are positioned to emit light to an edge of the light guide.

16. The backlight assembly of claim 1, further comprising one or more optical components for the control of light emission from the backlight assembly.

17. The backlight assembly of claim 16, wherein optical components include a specular reflector on a non-viewing side of the backlight assembly relative to the lightguide, and at least one brightness enhancing film on a viewing side of the backlight assembly relative to the lightguide.

18. A method of operating a backlight assembly for active dimming control comprising the steps of:
providing a backlight assembly including a light source; a light guide optically coupled to the light source that receives light from the light source; a substrate including an electrode layer and a hydrophobic surface located on the electrode layer, wherein the hydrophobic surface of the substrate is spaced apart from a surface of the light guide to define a cell gap; and an array of conductive liquid beads located within the cell gap;
wherein liquid beads that are subject to an actuation voltage applied to the electrode layer are in an actuated state, and liquid beads that are not subject to an actuation voltage applied to the electrode layer are in a non-actuated state; and
wherein when the liquid beads are in the non-actuated state, the liquid beads are in contact with the surface of the light guide for extracting light from the light guide, and when the liquid beads are in the actuated state, the liquid beads deform such that contact of the liquid beads with the surface of the light guide is reduced relative to the non-actuated state to reduce extraction of light from the lightguide, thereby dimming the backlight assembly;
the method further comprising sequentially operating the backlight assembly to illuminate the array of liquid beads in sequence by:
time-sequentially switching on the light source to apply respective data for each sequence; and
time-sequentially retaining an extracting zone within the array of liquid beads by maintaining the extracting zone in a non-actuated state for light extraction corresponding to the data, while generating a non-extracting zone that does not extract light by actuating liquid beads in the non-extracting zone;
wherein the backlight assembly is sequentially operated in a time of one frame during which the array of liquid beads is illuminated.

19. The method of operating a backlight assembly of claim 18, wherein the extracting zone corresponds in each sequence to a different row or column within the array of liquid beads.

20. The method of operating a backlight assembly of claim 18, wherein sequentially operating the backlight assembly includes placing the backlight assembly in an initial state in which the entire array of liquid beads is non-actuated, and no light emission data is being applied to the light source.
